(19) United States
(12) Patent Application Publication
(10) Pub. No.: US 2014/0258175 A1
(43) Pub. Date: Sep. 11, 2014

(54) Generating Personalized Investment Recommendations

(71) Applicant: THE MOTLEY FOOL HOLDINGS, INC., Alexandria, VA (US)

(72) Inventors: Ian Alexander TWOMBLY, Santa Clara, CA (US); Alexander Pape, Arlington, VA (US)

(73) Assignee: The Motley Fool Holdings, Inc., Alexandria, VA (US)

(21) Appl. No.: 13/791,416

(22) Filed: Mar. 8, 2013

(51) Int. Cl. G06Q 40/06

(52) U.S. Cl. CPC G06Q 40/06
USPC 705/36 R

(57) ABSTRACT

Disclosed herein are system, method, and computer program product embodiments for generating personalized investment recommendations. An embodiment operates by determining a high level asset allocation for a user, generating a baseline asset allocation based on current market data and performance analysis, adjusting the baseline asset allocation based on one or more user parameters, formulating an optimal asset allocation profile across one or more axes, and selecting particular assets satisfying the optimal asset allocation profile.

### BACKGROUND

Investment decisions are often made based on incomplete, out of date, statistically insignificant, and/or one size fits all information. Individual investors may seek out guidance by consulting with an advisor or attempt to make decisions based on analysis. However, existing approaches are prone to human error, bias, oversimplification, and/or rely almost exclusively on the supposed expertise of another person.

### BRIEF SUMMARY

Embodiments described herein include various computer implemented method, system, and computer program product embodiments, and combinations and sub-combinations thereof, for generating personalized investment recommendations. In an example embodiment, generating personalized investment recommendations includes automatically determining a high level asset allocation for a user, generating a baseline asset allocation based on current market data and performance analysis, adjusting the baseline asset allocation based on one or more user parameters, formulating an optimal asset allocation profile across one or more axes, and selecting particular assets satisfying the optimal asset allocation profile.

### BRIEF DESCRIPTION OF THE DRAWINGS

The accompanying drawings are incorporated herein and foul a part of the specification.

FIG. 1 is a block diagram of a system architecture, according to an example embodiment.

FIG. 2 is a block diagram of a personalized investment recommendation system, according to an example embodiment.

FIG. 3 is a flow diagram of a method for generating personalized investment recommendations, according to an example embodiment.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, method and/or computer program product embodiments, and/or combinations and sub-combinations thereof, for generating personalized investment recommendations.

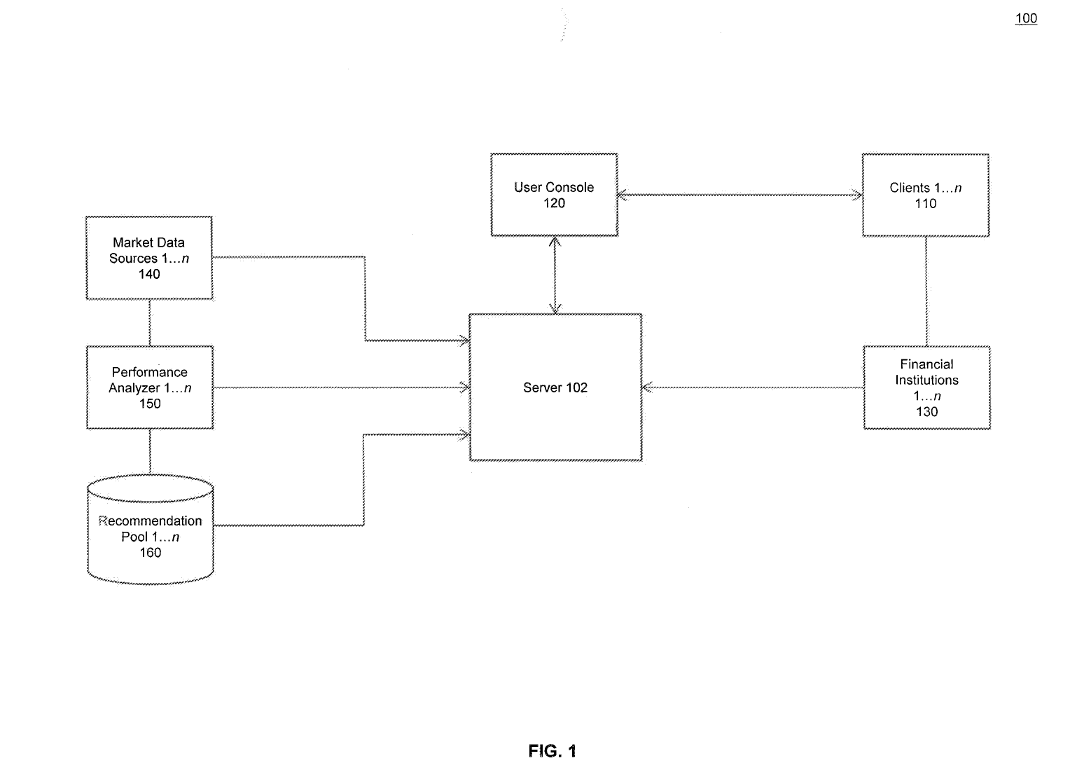

FIG. 1 shows a system architecture 100 for establishing a connection between one or more clients 1 . . . n 110 and a server 102, configured to generate personalized investment recommendations to one or more users, according to an example embodiment.

In an example embodiment, client 110 represents a human user who, through use of one or more computing devices, requests access to server 102. However, alternatively client 110 can be a computer. The terms “client” and “user” are used interchangeably to refer to any combination of hardware, software, entity, and/or human user accessing server 102 manually or automatically, such as client 110.

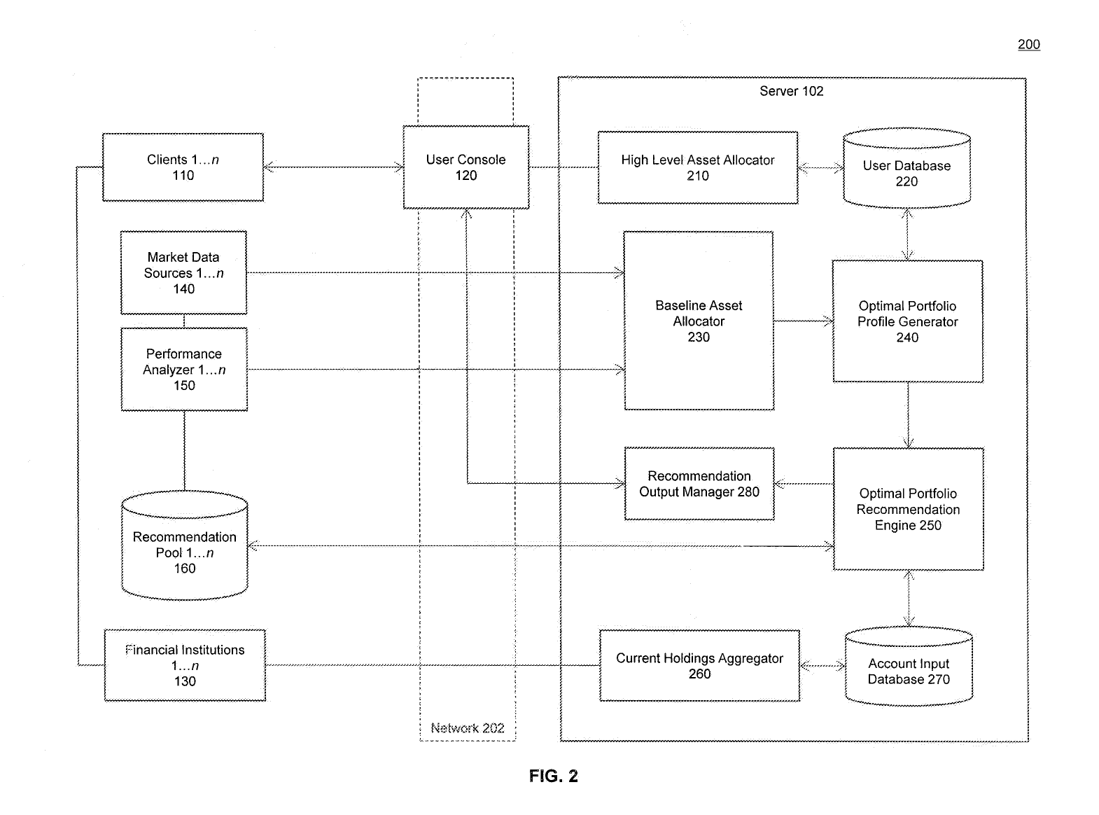

In an example embodiment, client 110 is operable to communicate over a network 202 with server 102 (see FIG. 2). Server 102 comprises a server and/or machine which operates alone or in combination with hardware and/or software coupled to a CPU and/or network 202 in accordance with, for example, a client-server model. Although client 110 is represented as a separate physical machine from server 102, this is by way of example and not of limitation. Client 110 may occupy the same system as server 102. Client 110 may be an application, or have access to an application, such as, for example, a user console 120.

In an example embodiment, client 110 is connected to and/or has established one or more accounts with one or more financial institutions 1 . . . n 130. Financial institution(s) 130 is connected to and/or has established a relationship with server 102, such that, data associated with an account associated with client 110 may be communicated in real-time, for example, over network 202, to server 102.

In an example embodiment, server 102 is connected to market data sources 1 . . . n 140, performance analyzer 1 . . . n 150, and/or recommendation pool 1 . . . n 160. Market data source(s) 140 may provide real-time, fundamentals, and/or historical data such as, for example, stock price quotes and/or associated dynamics, exchange traded fund (EFT) data and/or associated dynamics, market fundamentals, financial news, price to book, market cap, volatility and/or other trade-related data, such as, for example, data related to equity, fixed-income, financial derivatives, currency, and/or other investment instruments.

In an example embodiment, market data source 140 is connected to performance analyzer 150. Performance analyzer 150 comprises one or more analytical components configured to index and structure market data provided by market data source 140. In an example embodiment, performance analyzer 150 includes one or more models operable to analyze historical performance of individual stocks, ETFs, bonds, and/or other financial instruments. Such models may incorporate statistical methods and pattern recognition techniques for generating predictive analytics and indicators.

In an example embodiment, performance analyzer 150 uses time series forecasting models to predict future values based on previously observed values provided by market data source 140. Performance analyzer 150 evaluates the statistical significance of trends over time as well as the success or failure of individual picks, pickers, and/or forecasting models. Performance analyzer 150 may index particular stocks, bonds, ETFs, and/or other investment instruments based on indicators. Indicators may be comprised of one or more variables and/or correlations between variables which tend to predict target behaviors. In an example embodiment, a target behavior includes an increase in value over time.

In an example embodiment, recommendation pool 160 includes particular assets, such as, for example, particular stocks, bonds, ETFs, and/or other investment instruments which performance analyzer 150 has analyzed. By way of a non-limiting example, stocks, bonds, and/or ETFs for which a demonstrated history of performance has been identified as predicting growth by performance analyzer 150 are included in recommendation pool 160. In an example embodiment, analysis generated by performance analyzer 150 spans one or more axes such as, for example, a market capitalization axis (e.g., small cap, large cap), a sector axis (e.g., market sector), and/or a style axis (e.g., growth, value).

FIG. 2 shows a personalized investment recommendation system 200, according to an example embodiment.

In an example embodiment, server 102 includes a high level asset allocator 210.

High level asset allocator 210 is connected to user console 120 and may thereby receive inputs and/or data from client 110. High level asset allocator 210 may receive data from other sources such as, for example, from client 110 and/or from financial institution 130, for example over network 202. In an example embodiment, high level asset allocator 210 determines a high level asset allocation for client 110 by receiving inputs obtained from a survey, questionnaire, and/or interactive display presented on user console 120 to client 110. By way of example, not of limitation, survey questions may include “What is your birth date?” “Are you currently retired?” “About how long do you have until you retire?” “How long do you intend for your portfolio to last?” “Over the next five years, about how much money do you think you'll need to withdraw from your investments?” “In 2008, the stock market fell 40%. What did you do with your individual stocks?” and/or “How much fluctuation are you willing to take in your portfolio in the pursuit of returns?” A user may respond in yes/no form and/or provide additional data into form elements which may be transformed into structured input readable to, for example, user console 120 and/or high level asset allocator 210. Input may be stored in, for example, user database 220.

In an example embodiment, survey input elicited from client 110 populates one or more models configured to determine investment parameters for client 110 based on the input. By way of example, not of limitation, user parameters may include one or more measures of risk tolerance, length of time until assets are required, and/or length of time over which assets are to be drawn down for client 110. Data and/or inputs for calculating the one or more parameters may be obtained from client 110 and/or a financial institution 130 with or without a survey.

In an example embodiment, high level asset allocator 210 processes parameters and outputs a personalized high level asset allocation. A high level asset allocation may include one or more target percentages of, for example, cash, bond, and equity. High level asset allocator 210 stores the resulting output in a user database 220, along with the user parameters used to generate the high level asset allocation. High level allocation factors may be based on, for example, retirement target asset allocation models. In a non-limiting example, allocations include equity and bonds plus cash. Allocation may be based on how much should be optimally allocated out of the equity market based on a particular user's time horizon, risk tolerance, and/or cash needs. Cash needs may be weighted according to an indicated and/or specified time range (e.g., over the next 3 to 5 years). In the absence of or in addition to cash needs, factors may include the time horizon and the risk tolerance with respect to bonds. A remainder may be allocated into equities.

In an example embodiment, server 102 includes a baseline asset allocator 230 for determining an objectively optimal asset allocation, independent of the personalized high level asset allocation. Baseline asset allocator 230 is connected to market data source 140 and performance analyzer 150. Baseline asset allocator 230 generates a baseline asset allocation based on current market data and available analysis, determining an objectively optimal asset allocation by modeling variables derived from current market data provided by market source 140 and one or more indicators of historical performance provided by performance analyzer 150. In an example embodiment, the indicators include one or more statistically significant predictors of target behavior. Baseline asset allocator 230 outputs a model, ideal, and/or objectively optimal baseline asset allocation, based on one or more financial models configured by performance analyzer 150 to reflect target behaviors.

In an example embodiment, baseline asset allocator 230 outputs the baseline asset allocation to an optimal portfolio profile generator 240 on server 102. Optimal portfolio profile generator 240 receives the objective baseline asset allocation from baseline asset allocator 230 and accesses the user parameters from user database 220. Optimal portfolio profile generator 240 adjusts the baseline asset allocation based on the user parameters. Optimal portfolio profile generator 240 translates the one or more parameters into one or more discrete or continuous modifications to the baseline asset allocation. Parameters modify the baseline asset allocation according to a weighted point scale. For example, optimal portfolio profile generator 240 may weigh one or more factors in the baseline asset allocation (e.g., such as those determined or predicted by performance analyzer 150 to yield target behaviors) against one or more personalized user parameters to determine optimal allocations across one or more axes.

In an example, embodiment, a weighting function includes:

f=Vector Difference Market Cap+Vector Difference Sector+Vector Difference Style+Vector Difference N+Analyst Opinion Factor

In this example weighing function, Vector Difference for a given axis includes:

sqrt[(target-portfolio)̂2)/(target̂2)]

In this example weighing function, Analyst Opinion Factor may be an exponential function: g=exp(−ff*W*Opinions), where W is a weighting matrix with negative values for sell and hold recommendations to make them unfavorable and positive values for buy and buy first and/or core recommendations so that they become favorable. In this example weighting function, factor ff is a positive factor that is scaled depending on the number of stocks used to define the portfolio that is being fitted and is scaled so that the magnitude of the Analyst Opinion is an order of magnitude below a typical good fit measured for that number of stocks without such a factor being considered.

In an example embodiment, weighted point scales for modifying the baseline asset allocation are dynamic and may depend on which factors are considered and/or the axes being modified. In an example embodiment, one or more different weighted point scales may be encoded, stored, and/or cached on server 102, for example as a library. In a non-limiting example, weighted point scales are updated at intervals to reflect the evolution of factors considered, for example by performance analyzer 150, to be stable indicators. In an example embodiment, a baseline asset allocation may be adjusted by the actual target percentage in each axis category and/or the tolerance allowed about the target percentage (e.g., a target of X percentage +/−Y percentage). The tolerance allowed about the target percentage may depend on time horizon, risk tolerance, and willingness to bear volatility.

In an example embodiment, for a market cap axis, weightings may be exaggerated with respect to categories historically determined to outperform and/or which demonstrate stronger alpha as ability to take on the risk increases, and vice versa. For sector and style, a baseline asset allocation may be adjusted towards specified breakdowns of, for example, the S&P Equal-Weight Index based on the same or similar factors. By way of example, not of limitation, adjusting towards the S&P Equal-Weight Index increases diversification across axes is determined by performance analyzer 150 to be worth diversifying across. A similar analytical framework may apply to tolerances, such that the greater the ability to take on one or more types of risk, the more a particular user may be permitted to deviate before adjusting back towards the baseline asset allocation.

In an example embodiment, axes across which an optimal allocation for a user is determined by optimal portfolio profile generator 240 may include a market capitalization axis, a sector axis, and/or a style axis. A market capitalization axis may include categories of stocks, such as, for example, of companies with a market capitalization of less than one billion dollars (i.e., small cap), of companies with a market capitalization of five billion dollars or more (i.e., large cap), and/or other categories predicated on the total value of issued shares. A sector axis may include asset categories of assets broken down by sector (e.g., technology, health care, energy, utilities, and telecommunications). A style axis may include categories of assets classified, for example, as value or growth. A growth/value designation may be based on a fundamental data point, for example the Price to Book ratio. In an example embodiment, one or more style algorithms may be implemented to produce a continuum of values between growth and value, for example, as represented on a scale of 0 through 1. Other axes may include, price volatility, momentum (e.g., short, medium, and long term), a risk measure, Bayesian statistical models (e.g., likelihood of expected returns), income stream (e.g., dividend and/or options capabilities), market location (e.g., geography), community intelligence (e.g., analysis), asset location (e.g., accounts securities are held in), tax status/cost-basis, and/or holding periods. One having skill in the relevant art(s) will understand that axes other than those listed may be possible. One or more such axes may be implemented, added, configured, reconfigured, removed, modified, and/or dynamically updated.

One having skill in the relevant art(s) will understand that the term optimal is not limited to a single solution, but may refer to one or more equally or approximately equal results tailored to specific or generic investment goals, which may take into account risk tolerances, time frames, diversification objectives, as well as any other factor. What is or is not optimal may also be relative to a given benchmark, objective preference, goal, etc.

In an example embodiment, axes represent an array of investment criteria relevant to determining an optimal allocation of assets, which may include but are not limited to: stocks (e.g., dividend, value, growth, sector specific, preferred, blends, large-cap, mid-cap, small-cap, micro-cap), exchange traded funds (ETFs), cash/cash equivalents (e.g., deposit account, money market fund), fixed interest securities (e.g., bonds, investment-grade/junk, government/corporate, short-term, intermediate, long-term, domestic, foreign, emerging, frontier), public/private equities (e.g., domestic, foreign, emerging, frontier), convertible securities, commodities (e.g., metals, broad basket, agriculture, energy), real estate (e.g., commercial, residential, REIT), collectibles (e.g., art, stamps, coins, wine etc.), insurance products (e.g., annuity, life settlements, catastrophe bonds, life insurance), derivatives (e.g., long-short, market neutral, options, collateralized debt, futures), foreign currency, venture capital, leveraged buyout, merger arbitrage, distressed securities, bonds, commodities, and/or other investment instruments known or later developed.

In an example embodiment, one or more axes may take into account personalized criteria based on user preferences, a user transaction history, current holdings, and/or other behavioral characteristics which may be associated with a user and/or which may be useful for generating personalized investment recommendations. Such user criteria may be stored in user database 220. User preferences may influence a baseline asset allocation as determined by performance analyzer 150 (e.g., using a weighted point scale). For example, and without limitation, user preferences which are contrary to reliable predictors may be minimized, whereas user preferences directed to discretionary and/or neutral attributes may be allowed to influence the baseline asset allocation up to an optimal threshold and/or orient the selection of particular assets to be recommended.

In a non-limiting example, each axis is determined by performance analyzer 150 to have unique characteristics and/or specific risk/return profiles, across which an optimal allocation for a particular user may be determined by optimal portfolio profile generator 240. In an example embodiment, each asset allocation across a particular axis combines to a whole, such as, for example, a total of 100 percent, distributed across one or more of the categories for a particular axis. In an example embodiment, optimal portfolio profile generator 240 formulates an optimal asset allocation profile across one or more axes.

In an example embodiment, an optimal asset allocation profile is populated with a selection of particular assets (e.g., individual stock picks) which satisfy the optimal asset allocation profile generated by optimal portfolio profile generator 240. More than a single portfolio may satisfy, or satisfy to within a threshold, the optimal asset allocation profile. A threshold may be defined by performance analyzer 150 as sufficient and/or sufficiently likely yield one or more target behaviors reflected in the optimal asset allocation profile.

In an example embodiment, assets are selected from recommendation pool 160 by optimal portfolio recommendation engine 250. Optimal asset allocation profiles generated by optimal portfolio profile generator 240 are populated with particular asset selections determined by an optimal portfolio recommendation engine 250. For example, optimal portfolio recommendation engine 250 receives one or more data structures corresponding to an optimal asset allocation profile from optimal portfolio profile generator 240.

In an example embodiment, optimal portfolio recommendation engine 250 selects particular assets satisfying the optimal asset allocation profile from recommendation pool 160. By way of example, not of limitation, optimal portfolio recommendation engine 250 determines a target selection of particular assets producing a best fit to the optimal asset allocation profile using a genetic algorithm. In an example embodiment, optimal portfolio recommendation engine 250 determines a population of assets from which to select one or more particular assets, randomly samples the population to generate multiple selections of particular assets, crosses and randomly modifies the selections of particular assets in successive generations, and determines a target selection of particular assets from among resulting generations. In an example embodiment, the target selection among a plurality of satisfactory selections is determined using one or more algorithms to perform a best fit optimization (e.g., a non-negative, constrained non-linear minimization function). Other optimization implementations are possible to determine closeness of fit and/or closeness in similarity to the optimal asset allocation profile. In an example embodiment, the closest and/or the most similar is determined to be the target selection of assets (e.g., actual stock picks). By way of a non-limiting example, an interior-point algorithm is used to perform the fitting of non-linear constraints to determine percentages. One having skill in the relevant art(s) will understand that various implementations are possible including but not limited to those using active-set, trust-region-reflective, Levenberg-Marquart, and/or using genetic algorithms and/or using simulated annealing. Optimal portfolio recommendation engine 250 outputs a target portfolio based on the selection.

In an example embodiment, a first generation of solution seeds may be numbered between, for example, ½×-1× the total number of data points in recommendation pool 160 to be selected from. By way of a non-limiting example, if 300 stocks are indexed in a recommendation pool 160 from which to choose, then the initial generation will contain between 150-300 initial solutions to seed the selection algorithm. Those 150-300 initial solutions may be seeded by drawing a random number between 0-1 for each of the axes (e.g., market cap, style, sector) and assigning a random number to one of the categories within the axes based, for example, on the magnitude of each allocation target category (e.g., for a weight of 0.1 as a target for the “industrials” sector, then a 10 percent chance exists for choosing industrials along the sector axis). Recommendation pool 160 may be randomized and searched for a stock that most closely fits the specification. In the event of a tie, the first occurrence of the tying values is chosen. Such a tying rule may apply to partial matches (e.g., a 2 out of 3 match in recommendation pool 160). A selected stock is placed as an entry in the specific solution within the seed generation and is removed from consideration until the remaining stocks in recommendation pool 160 have been selected. Such a process may continue until a particular solution is filled before moving on to the next solution. Eventually no more stocks are left in recommendation pool 160, at which point the original complete recommendation pool 160 is returned, randomized, and made available for picking. One having skill in the relevant art(s) will understand that the above stated example may apply to any asset type indexed in recommendation pool 160 and is not limited to stocks. Stocks are referred to by way of example, not limitation.

In an example embodiment, sever 102 includes a current holdings aggregator 260. Current holdings aggregator 260 is connected for example, over network 202, to financial institution 130. In an example embodiment, a third-party service may provide or facilitate access to account information managed by financial institution 130. For example, client 110 may authorize the exchange of account information between financial institution 130 and sever 102. In an example embodiment, client 110 may provide account information to server 102. Information includes a complete or partial inventory of current asset holdings on a per asset basis. Account information may also include specific constraints on the sale or redistribution of particular assets and/or asset classes (e.g., retirement fund, committed assets, assets being drawn down). In an example embodiment, a constraint includes one or more assets and/or asset classes designated by client 110 as not sellable. Client 110 may provide specific input when completing the personalization survey. Client 110 may also provide and/or trigger equivalent indications to appear in account settings and/or current holdings data accessed from financial institution 130. Client 110 may provide indications and or make current holdings data available by interacting with user console 120.

In an example embodiment, current holdings aggregator 260 aggregates, requests, and/or receives information associated with a user's current holdings. Current holdings aggregator 260 provides one or more data structures representing current holdings data to an account input database 270 for storage and/or retrieval. In an example embodiment, optimal portfolio recommendation engine 250 fetches and/or is provided current holdings data for client 110. Optimal portfolio recommendation engine 250 reconciles constraints and overlap where indicated in the current holdings data. For example, optimal portfolio recommendation engine 250 backs out recommendations to buy particular assets already held by client 110. In an example embodiment, optimal portfolio recommendation engine 250 backs out recommendations to sell assets and/or asset classes upon which constraints have been imposed. Optimal portfolio recommendation engine 250 thereby reconciles the target portfolio to eliminate recommendations overlapping current holdings and/or which conflict with one or more constraints on buying or selling. In an example embodiment, optimal portfolio recommendation engine 250 generates a reconciled target portfolio.

In an example embodiment, optimal portfolio recommendation engine 250 may recommend preservation of current holdings which overlap with the target portfolio. In an example embodiment, optimal portfolio recommendation engine 250 may process one or more specific constraints on selling current holdings where indicated, for example, by the user, by an account setting, by an asset type, and/or other indications determined based on context. Upon undertaking one or more measures to reconcile the target portfolio, optimal portfolio recommendation engine 250 generates a reconciled target portfolio. Optimal portfolio recommendation engine 250 may be configured to have a bias to sell holdings for which historical performance has not been determined and/or to buy assets for which historical performance has been evaluated, for example, by performance analyzer 150. In an example embodiment, optimal portfolio recommendation engine 250 may be adjusted to override and/or balance such a bias in accordance with a weighted point scale.

In an example embodiment, optimal portfolio recommendation engine 250 outputs a reconciled target portfolio to a recommendation output manager 280. Recommendation output manager 280 processes the reconciled target portfolio for display in the form of, for example, one or more particular buy and/or sell recommendations. Recommendation output manager 280 may provide such recommendations to client 110, for example, by displaying the output in user console 120, by transmitting one or more summaries thereof directly to client 110, and/or by storing one or more outputs thereof in user database 220.

In an example embodiment, buy and/or sell recommendations may be apportioned into units of capital based on, for example, the degree of closeness to the target portfolio resulting if a user follows one or more of the output recommendations. In a non-limiting example, an output recommendation to sell holdings and/or to purchase a given number of recommended stocks is displayed to the user so as to demonstrate how much closer to the optimal asset allocation profile a user gets were the user to follow one or more of the output recommendations (e.g., five percent sell/buy increments, steps, actions etc.). In an example embodiment, a display is generated by recommendation output manager 280 to quantitatively illustrate to a user the potential benefit from partial, successive, ranked, and/or incremented actions taken in accordance with the output recommendations.

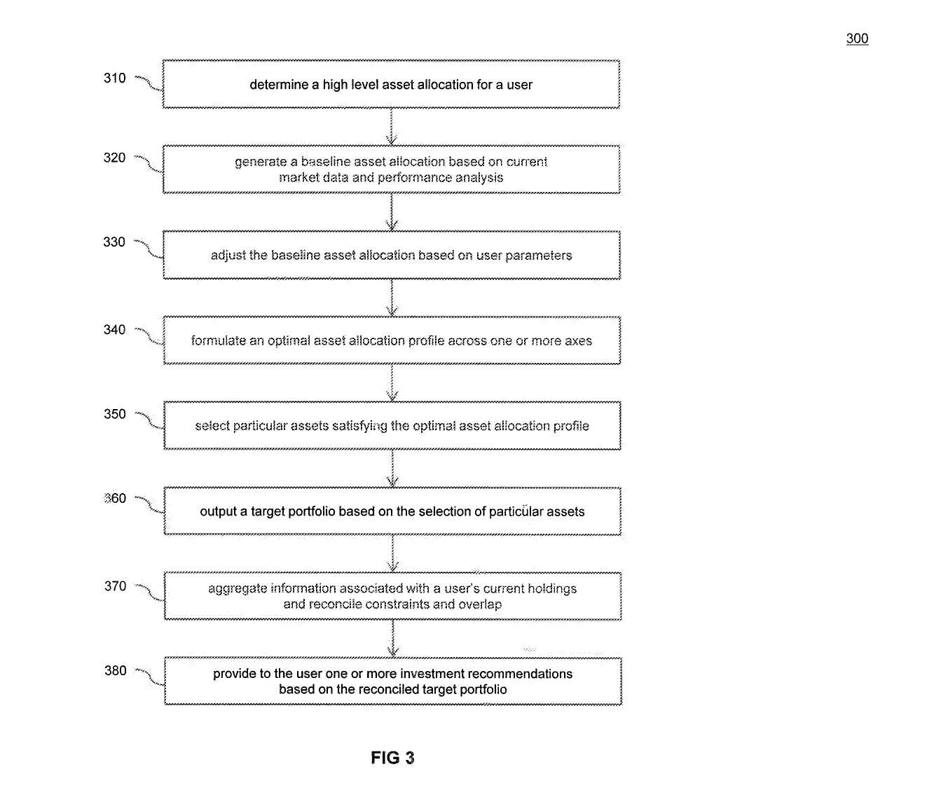

FIG. 3 is a flow diagram showing a method for generating personalized investment recommendations, according to an example embodiment. Method 300 begins at step 310, where a high level asset allocation for a user is determined.

In an example embodiment, in step 310, high level asset allocator 210 determines a high level asset allocation for client 110 by receiving inputs obtained from a survey, questionnaire, and/or interactive display presented to client 110. The survey input from client 110 populates one or more models configured to determine investment parameters for client 110 based on the input. High level asset allocator 210 processes parameters and outputs a personalized high level asset allocation. A high level asset allocation includes one or more target percentages of, for example, cash, bond, equity, etc. High level asset allocator 210 stores the high level asset allocation in a user database 220.

By way of example, not of limitation, target behavior considers retirement target asset allocation models. In a non-limiting example, allocations include equity and bonds plus cash. Allocation may be based on how much should be optimally allocated out of the equity market based on a particular user's time horizon, risk tolerance, and/or cash needs. Cash needs may be weighted according to an indicated and/or specified time range (e.g., over next 3 to 5 years). In the absence of or in addition to cash needs, factors may include the time horizon and the risk tolerance with respect to bonds.

In an example embodiment, in step 320, a baseline asset allocation is generated based on current market data and performance analysis. Baseline asset allocator 230 generates a baseline asset allocation based on current market data and available analysis. Baseline asset allocator 230 models variables derived from current market data, provided by market source 140, and one or more indicators of historical performance, provided by performance analyzer 150, and determines an objectively optimal asset allocation.

In an example embodiment, baseline asset allocator 230 determines an objectively optimal asset allocation by modeling variables derived from current market data from market data source 140 and one or more indicators based on historical performance, wherein the one or more indicators include statistically significant predictors of target behavior determined by performance analyzer 150.

In an example embodiment, baseline asset allocator 230 determines an objectively optimal asset allocation by modeling variables derived from current market data and one or more indicators based on historical performance, wherein the one or more indicators include statistically significant predictors of target behavior. Baseline asset allocator 230 outputs an objectively optimal baseline asset allocation predicted to yield target behaviors according to one or more models configured by performance analyzer 150.

By way of example, not of limitation, target behavior may include optimal and/or objective alpha (e.g., risk-adjusted measure of active return on an investment) relative to, for example, beta (e.g., measure of volatility relative to the market). Target behavior may include positive investment performance relative to risk involved. Other target behaviors may be based on, for example, a capital asset pricing model (CAPM), which may be used to determine appropriate rates of return for particular assets and/or asset classes, in a non-limiting example, target behavior may include an appropriate required rate of return on a particular asset or asset class when that asset or asset class is added to a well-diversified portfolio given the systematic risk associated with a particular asset or asset class. Such a model may take into account, for example, asset or asset class sensitivity to systemic risk, expected return of the market, and/or expected return of a risk-free asset or asset class.

In an example embodiment, in step 330, the baseline asset allocation is adjusted based on user parameters. Baseline asset allocator 230 outputs the baseline asset allocation to an optimal portfolio profile generator 240. Optimal portfolio profile generator 240 receives the objective baseline asset allocation from baseline asset allocator 230 and accesses user parameters, which may be stored in user database 220. Optimal portfolio profile generator 240 adjusts the baseline asset allocation based on the user parameters. Optimal portfolio profile generator 240 translates the one or more investment parameters into one or more modifications to the baseline asset allocation.

In an example embodiment, in step 340, an optimal asset allocation profile across one or more axes is formulated. Adjusting the baseline asset allocation based on the high level asset allocation includes translating investment parameters reflected in the high level asset allocation into one or more modifications to the baseline asset allocation along the one or more axes. In an example embodiment, parameters reflected in the high level asset allocation modify the baseline asset allocation according to a weighted point scale.

In an example embodiment, optimal portfolio profile generator 240 weighs one or more factors in the baseline asset allocation, such as those determined by performance analyzer 150 to produce target behaviors, against the personalized user parameters to determine optimal allocations across one or more axes.

In an example embodiment, optimal portfolio profile generator 240 formulates an optimal asset allocation profile across one or more axes, the axes comprising one or more of a market capitalization axis, a sector axis, and a style axis. Other axes are possible.

In an example embodiment, in step 350, particular assets satisfying the optimal asset allocation profile are selected. An optimal asset allocation profile is populated with one or more selections of particular assets (e.g., individual stock picks) which satisfy the optimal asset allocation profile generated by optimal portfolio profile generator 240.

In an example embodiment, assets are selected from recommendation pool 160 by optimal portfolio recommendation engine 250. Optimal asset allocation profiles generated by optimal portfolio profile generator 240 are populated with particular asset selections determined by optimal portfolio recommendation engine 250. In an example embodiment, optimal portfolio recommendation engine 250 determines populations of assets from which to select one or more particular assets (e.g., recommendation pool 160), randomly samples the population to generate multiple selections of particular assets, crosses and randomly modifies selections of particular assets in generations, and determines a target selection of particular assets from among resulting generations based on a best fit to the optimal asset allocation profile. In an example embodiment, the target selection among a plurality of satisfactory selections is determined using a best fit optimization to determine closeness of fit and/or closeness in similarity to the optimal asset allocation profile. In an example embodiment, the closest, most similar, and/or best fitting selection is identified as the target selection. In an example embodiment, more than one target selection may be generated and a plurality of selections may satisfy the optimal asset allocation profile.

In an example embodiment, in step 360, a target portfolio based on the selection of particular assets is output. Optimal portfolio recommendation engine 250 outputs a target portfolio based on the selection.

In an example embodiment, in step 370, data and information associated with a user's current holdings are aggregated and constraints and overlap are reconciled. Current holdings aggregator 260 aggregates, requests, and/or receives information associated with a user's current holdings. Current holdings aggregator 260 provides current holdings data to account input database 270 for storage and/or retrieval.

In an example embodiment, optimal portfolio recommendation engine 250 fetches and/or is provided current holdings data for client 110. Optimal portfolio recommendation engine 250 reconciles constraints and overlap, for example, where indicated in the current holdings data. Optimal portfolio recommendation engine 250 backs out recommendations to buy particular assets already held by a user. Optimal portfolio recommendation engine 250 backs out recommendations to buy/sell assets and/or asset classes constrained by, for example, sale restrictions (e.g., as required by financial regulations, required by financial institution 130, by user preference/election, and/or may be sellable but at substantial cost and/or inefficiency). Constraints need not be expressly indicated, but may be determined, for example by optimal portfolio recommendation engine 250, based on criteria and/or context such as, for example, data regarding the user (e.g., age), account settings, type of asset, asset accessibility, requirements, financial plans, and/or date of acquisition.

By way of example, not of limitation, optimal portfolio recommendation engine 250 reconciles a target portfolio with current holdings by comparing, on a per asset basis, an inventory of current holdings to the selection of particular assets reflected in the target portfolio. Optimal portfolio recommendation engine 250 assimilates the target portfolio to constraints, for example, where expressly indicated and/or determined by context. In an example embodiment, optimal portfolio recommendation engine 250 may eliminate target portfolio recommendations which overlap with a user's current holdings (e.g., are already held in a corresponding allocation) and/or which conflict with one or more constraints. In an example embodiment, optimal portfolio recommendation engine 250 recommends the preservation of current holdings which overlap with the target portfolio.

In an example embodiment, after reconciling any outstanding constraints and/or backing out recommendations to purchase assets which are already held, optimal portfolio recommendation engine 250 generates a reconciled target portfolio.

In an example embodiment, in step 380, one or more personalized investment recommendations are provided to the user based on the reconciled target portfolio.

In an example embodiment, optimal portfolio recommendation engine 250 outputs a reconciled target portfolio to a recommendation output manager 280. Recommendation output manager 280 processes the reconciled target portfolio for display in the form of, for example, one or more particular buy and/or sell recommendations. Recommendation output manager 280 provides recommendations to client 110, for example, by displaying the output in user console 120, by transmitting one or more summaries thereof directly to client 110, and/or by storing one or more outputs thereof in user database 220.

In an example embodiment, recommendation manager 280 logs and stores output by personalized investment recommendation system 200. One or more logs may be stored for a particular user in user database 220. In an example embodiment, client 110 may be restricted in the number of times, the frequency, and/or the accessibility to personalized investment recommendation system 200. Logs may be compared against current holdings to determine a user's response to receiving personalized investment recommendations.

In an example embodiment, personalized investment recommendation system 200 produces a different target portfolio each time a user requests a personalized investment recommendation. In an example embodiment, the size of recommendation pool 160 is sufficiently large to make successive, identical outputs improbable.

Example Computer System

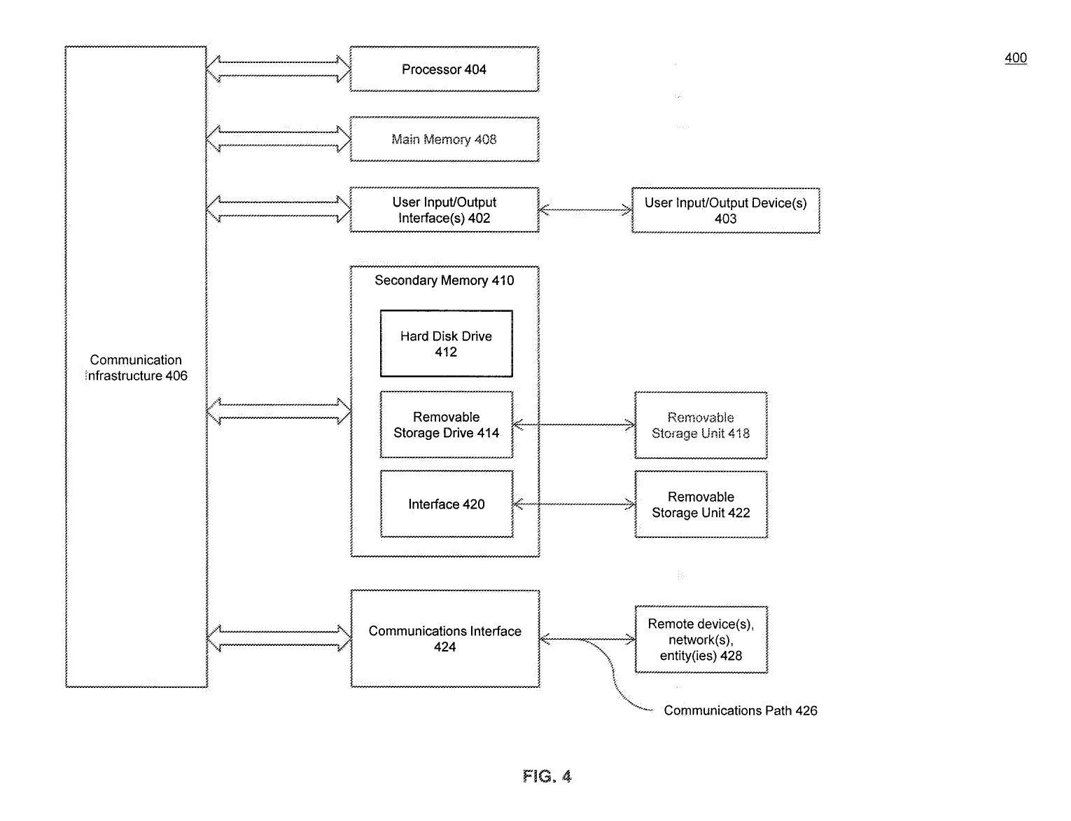

Various embodiments can be implemented, for example, using one or more well-known computer systems, such as computer system 400 shown in FIG. 4. Computer system 400 can be any well-known computer capable of performing the functions described herein, such as computers available from International Business Machines, Apple, Sun, HP, Dell, Sony, Toshiba, etc.

Computer system 400 includes one or more processors (also called central processing units, or CPUs), such as a processor 404. Processor 404 is connected to a communication infrastructure or bus 406.

Computer system 400 also includes user input/output device(s) 403, such as monitors, keyboards, pointing devices, etc., which communicate with communication infrastructure 406 through user input/output interface(s) 402.

Computer system 400 also includes a main or primary memory 408, such as random access memory (RAM). Main memory 408 may include one or more levels of cache. Main memory 408 has stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 includes a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 reads from and/or writes to removable storage unit 418 in a well-known manner.

According to an exemplary embodiment, secondary memory 410 may include other means, instrumentalities or other approaches for allowing computer programs and/or other instructions and/or data to be accessed by computer system 400. Such means, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 enables computer system 400 to communicate and interact with any combination of remote devices, remote networks, remote entities, etc. (individually and collectively referenced by reference number 428). For example, communication interface 424 may allow computer system 400 to communicate with remote devices 428 over communications path 426, which may be wired and/or wireless, and which may include any combination of LANs, WANs, the Internet, etc. Control logic and/or data may be transmitted to and from computer system 400 via communication path 426.

In an embodiment, a tangible apparatus or article of manufacture comprising a tangible computer useable or readable medium having control logic (software) stored thereon is also referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 4. In particular, embodiments may operate with software, hardware, and/or operating system implementations other than those described herein.

Conclusion

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

1. A computer implemented method, comprising:
determining a high level asset allocation for a user;
generating a baseline asset allocation based on current market data and performance analysis;
adjusting the baseline asset allocation based on one or more user inputs, comprising at least one of a length of time assets are allocated or a length of time over which assets are to be drawn down;
formulating an enhanced asset allocation profile across one or more parameters of the baseline asset allocation, wherein formulating comprises weighing one or more factors in the baseline asset allocation against one or more parameters from the high level asset allocation for the user; and
selecting particular assets satisfying the enhanced asset allocation profile;
wherein at least one of said determining, generating, adjusting, formulating, and selecting is executed using one or more computers.

2. The method of claim 1, further comprising:
outputting a target portfolio based on the selection of particular assets;
aggregating information associated with a user's current holdings and reconciling constraints and overlap; and
providing to the user one or more investment recommendations based on the reconciled target portfolio.

3. The method of claim 2, wherein reconciling existing constraints and overlap comprises:
recommending preservation of current holdings which overlap with the target portfolio;
processing specific constraints on selling current holdings; and
generating a reconciled target portfolio.

4. The method of claim 1, the determining further comprising:
calculating investment parameters based on user input obtained from a survey, the investment parameters comprising one or more measures of a risk tolerance associated with the user, length of time until assets are required by the user, and length of time over which assets are to be drawn down by the user.

5. The method of claim 1, the generating further comprising:
determining an objectively enhanced asset allocation by modeling variables derived from current market data and one or more indicators based on historical performance, wherein the one or more indicators include statistically significant predictors of desired market performance.

6. The method of claim 1, the adjusting further comprising:
translating one or more investment parameters into one or more modifications to the baseline asset allocation along one or more parameters, the parameters comprising at least one of a market capitalization, a sector, or a style.

7. The method of claim 1, the selecting further comprising:
determining a population of assets from which to select one or more particular assets;
randomly sampling the population to generate multiple selections of particular assets;
crossing and randomly modifying selections of particular assets in generations of a genetic algorithm; and
determining a target selection of particular assets from among resulting generations of the genetic algorithm based on a best fit to the enhanced asset allocation profile.

8. A system, comprising:
a memory; and
at least one processor coupled to the memory and configured to:
determine a high level asset allocation for a user;
generate a baseline asset allocation based on current market data and performance analysis;
adjust the baseline asset allocation based on one or more user inputs, comprising at least one of a length of time assets are allocated and a length of time over which assets are to be drawn down;
formulate an enhanced asset allocation profile across one or more parameters of the baseline asset allocation; wherein formulating comprises weighing one or more factors in the baseline asset allocation against one or more parameters from high level asset allocation for the user; and
select particular assets satisfying the enhanced asset allocation profile.

9. The system of claim 8, the at least one processor further configured to:
output a target portfolio based on the selection of particular assets;
aggregate information associated with a user's current holdings and reconcile constraints and overlap; and
provide to the user one or more investment recommendations based on the reconciled target portfolio.

10. The system of claim 9, the at least one processor when reconciling constraints and overlap is further configured to:
recommend preservation of current holdings which overlap with the target portfolio;
process specific constraints on selling current holdings; and
generate a reconciled target portfolio.

11. The system of claim 8, the at least one processor when determining is further configured to:
calculate investment parameters based on user input obtained from a survey, the investment parameters comprising one or more measures of a risk tolerance associated with the user, length of time until assets are required by the user, and length of time over which assets are to be drawn down by the user.

12. The system of claim 8, the at least one processor when generating is further configured to:
determine an objectively enhanced asset allocation by modeling variables derived from current market data and one or more indicators based on historical performance, wherein the one or more indicators include statistically significant predictors of desired market performance.

13. The system of claim 8, the at least one processor when adjusting is further configured to:
translate one or more investment parameters into one or more modifications to the baseline asset allocation along one or more parameters, the parameters comprising at least one of a market capitalization, a sector, or a style.

14. The system of claim 8, the at least one processor when selecting is further configured to:
determine a population of assets from which to select one or more particular assets;
randomly sample the population to generate multiple selections of particular assets;
cross and randomly modify selections of particular assets in generations of a genetic algorithm; and
determine a target selection of particular assets from among resulting generations of the genetic algorithm based on a best fit to the enhanced asset allocation profile.

15. A tangible computer-readable device having instructions stored thereon that, when executed by at least one computing device, causes the at least one computing device to perform operations comprising:
determining a high level asset allocation for a user;
generating a baseline asset allocation based on current market data and performance analysis;
adjusting the baseline asset allocation based on one or more user inputs, comprising at least one of a length of time assets are allocated and a length of time over which assets are to be drawn down;
formulating an enhanced asset allocation profile across one or more parameters of the baseline asset allocation, wherein formulating comprises weighing one or more factors in the baseline asset allocation against one or more parameters from the high level asset allocation for the user; and
selecting particular assets satisfying the enhanced asset allocation profile.

16. The computer-readable device of claim 15, the operations further comprising:
outputting a target portfolio based on the selection of particular assets;
aggregating information associated with a user's current holdings and reconciling constraints and overlap; and
providing to the user one or more investment recommendations based on the reconciled target portfolio.

17. The computer-readable device of claim 16, the reconciling operations further comprising:
recommending preservation of current holdings which overlap with the target portfolio;
processing specific constraints on selling current holdings; and
generating a reconciled target portfolio.

18. The computer-readable device of claim 15, the determining operations further comprising:
calculating investment parameters based on user input obtained from a survey, the investment parameters comprising one or more measures of a risk tolerance associated with the user, length of time until assets are required by the user, and length of time over which assets are to be drawn down by the user.

19. The computer-readable device of claim 15, the adjusting operations further comprising:
translating one or more investment parameters into one or more modifications to the baseline asset allocation along one or more parameters, the parameters comprising at least one of a market capitalization, a sector, or a style.

20. The computer-readable device of claim 15, the selecting operations further comprising:
determining a population of assets from which to select one or more particular assets;
randomly sampling the population to generate multiple selections of particular assets;
crossing and randomly modifying selections of particular assets in generations of a genetic algorithm; and
determining a target selection of particular assets from among resulting generations of the genetic algorithm based on a best fit to the enhanced asset allocation profile.

21. The method of claim 1, wherein generating the baseline asset allocation comprises:
generating the baseline asset allocation independently of the high level asset allocation for the user.

22. The method of claim 1, wherein the one or more factors in the baseline asset allocation are weighted by a market capitalization vector difference, a sector vector difference, a style vector difference, and an analyst opinion factor.

23. The method of claim 22, wherein the analyst opinion factor is a weighting of analyst opinions against a matrix representing sell, hold, buy, and core recommendations.
